(19) United States
(12) Patent Application Publication
(10) Pub. No.: US 2026/0142716 A1
(43) Pub. Date: May 21, 2026

(54) MACHINE LEARNING BASED BEAMFORMING SATELLITE COMMUNICATION SYSTEM

(71) Applicant: Qoherent Inc., Markham (CA)

(72) Inventors: Ashkan Eshaghbeigi, Toronto (CA); Lorne Swersky, Toronto (CA); Adrian Kaczmarczyk, Guelph (CA); Alec Digby, Toronto (CA); Pasquale Leone, Toronto (CA); Hatem Abou-Zeid, Markham (CA); Fazal Khan, Markham (CA); Omar Marshaal, Markham (CA); Mohammad Hallaq, Markham (CA); Elsayed Mohammed Elsayed Mostafa Mohammed, Toronto (CA)

(21) Appl. No.: 19/397,382

(22) Filed: Nov. 21, 2025

Related U.S. Application Data
(60) Provisional application No. 63/723,421, filed on Nov. 21, 2024.

(51) Int. Cl. H04B 7/185; H04B 7/06

(52) U.S. Cl. CPC H04B 7/18513; H04B 7/0617

(57) ABSTRACT

A system and method of beamforming radio frequency (RF) signals in a satellite communication system. The method comprises receiving, at an antenna array that includes a set of antenna devices in communication with a control module of at least one of a satellite communication device and a base station communication device, a RF signal transmission, and based at least in part on a trained machine learning (ML) beamforming model, selecting a beamforming subset of the antenna devices of the antenna array that provides a best inference of an azimuth angle and an elevation angle of the satellite communication device relative to the base communication device.

### TECHNICAL FIELD

Disclosures herein relate to radio frequency signal machine learning based beamforming in satellite communication systems.

### BACKGROUND

The spectrum environment for the Satellite Communications (SATCOM) industry is becoming congested, contested, and complex, due to increasingly massive satellite constellation deployments. Beamforming is a technology that allows for highly directional radio frequency (RF) signals between satellites, reducing interference. This helps to create versatile, flexible, and adaptive links. A drawback is that calculating the Angle of Arrival (AoA) of a signal, which is an essential step in beamforming, can consume a significant amount of the limited computational resources on both base terminals and satellites. Newly activated base terminals that have lost their communication links can take a long time to find and establish a new link with their desired satellite, resulting in significant downtime. It thus appears that reducing the time or compute cost for detecting or identifying the angle of arrival and a response angle (angle of departure) could reduce the time for acquisition,

In the field of RF communications, it is often advantageous to increase the directivity of an antenna system, for example to focus transmitted power towards a specific target, to remove a source of interference while receiving, or to estimate the bearing of an RF transmitter relative to the known orientation of an antenna system. Increased directivity may be achieved by combining a number of antenna elements together into an array, according to a regularly spaced pattern. Electromagnetic waves that impinge on the array hit each element at different times according to the known geometry of the array, the incident angle of the EM waves, and the speed of light. The wavefront's time differences of arrival at each of the array elements corresponds to a phase difference in the AC voltages induced on each element by the incident EM wave, and by summing each of these voltages in different linear combinations of amplitude and phase we can cause constructive interference for EM waves incident at some angles, and destructive interference at other incident angles. This amounts to an increase in directivity within a predictable, controllable range of incident angles, which is equally applicable both on transmission and reception.

### SUMMARY

In one embodiment, a method of beamforming radio-frequency signals in a satellite communication system comprises receiving an RF transmission at an antenna array of multiple antenna devices in communication with a control module, processing the received signal with a trained convolutional neural network to recognize and classify interference in real time, and selecting a subset of antenna devices with corresponding phase and gain settings to maximize a desired signal while adaptively suppressing unwanted interference. The ML model is trained end-to-end on synthetic and real-world datasets, compensates for random phase and gain offsets to operate on calibrated and uncalibrated receivers, and incorporates a differentiable phase-shift-and-sum layer. The method may further include determining azimuth and elevation in two axes based on angle of arrival and departure, preparing hyperparameter training sets spanning RF signals, modulations, bandwidths and gains, capturing time- and phase-synchronized IQ samples under varying angles, distances and environmental conditions, and performing receiver-side nulling or transmitter-side beam control to resolve multiple simultaneous sources and generalize to out-of-distribution interference scenarios.

In another embodiment, a satellite communication server system comprises an antenna array coupled to a control module that includes one or more processors and memory storing executable instructions to receive raw in-phase and quadrature data streams from each antenna channel, process these streams through the trained convolutional neural network and differentiable phase-shift-and-sum layer to perform angle-of-arrival estimation without commanding beam steering, and apply receiver-side nulling by digitally adjusting per-channel phase and gain or post-processing IQ streams to suppress interference. When transmit beam control is desired, the system computes and commands phase and gain parameters for transmitter-side nulling and beam shaping to reduce radiated energy toward protected directions while maintaining service to target directions. This system operates on small arrays or subarrays, outputs azimuth, elevation and per-channel parameters, and can interface with a radio resource scheduler to adapt to environmental and regulatory conditions.

In a further embodiment, a non-transitory computer-readable storage medium stores instructions executable by one or more processors to perform operations comprising receiving raw in-phase and quadrature data streams from an antenna array and processing them with the trained machine learning beamforming model to carry out angle-of-arrival estimation and receiver-side nulling without issuing array control commands, and optionally computing and commanding transmit-side phase and gain parameters for beam shaping to limit energy toward protected directions and maintain energy toward target directions. The model is trained end-to-end using synthetic and real-world datasets, compensates for random channel offsets with a requirement of channel consistency during operation, and is configured to output both azimuth/elevation estimates and per-channel phase and gain parameters while supporting small arrays and subarrays.

### BRIEF DESCRIPTION OF THE DRAWINGS

FIG. 1 illustrates, in an example embodiment, a machine learning based beamforming satellite communication system.

FIG. 2 illustrates, in an example embodiment, an architecture of a control module in accordance with a machine learning based beamforming satellite communication server computing system.

FIG. 3 illustrates, in an example embodiment, a method of operation in a machine learning based beamforming satellite communication system.

FIG. 4 illustrates, in an example embodiment, a method of training a machine learning neural network model for a beamforming satellite communication system.

FIG. 5 illustrates, in an example embodiment, a method of applying a pruning procedure in training a machine learning based beamforming satellite communication system.

### DETAILED DESCRIPTION

Embodiments herein, among other aspects, provide solutions for artificial intelligence machine learning (ML) beamforming model, a system and methodology for producing an ultra-light footprint, ultra-minimalist, resilient, and rapid RF beam selection and RF beam forming application for space-based satellite sensing and communications.

Among other benefits, embodiments herein further provide solutions that could be deployed to satellites and base terminals which would automatically and passively detect its counterpart, select a receiving beam angle, then respond with the appropriate transmission beam angle. In particular, solutions herein provide a framework for models that could be deployed to satellites and base terminals enabling them to automatically detect the angle of arrival (AoA) of a signal of interest, then retransmit at the same angle as its angle of departure (AoD). Advantageously, solutions disclosed herein have the potential to enable robust, secure, and high throughput communication access in areas that were previously inaccessible.

In particular, beamforming solutions herein provide a machine learning (ML) approach to beam angle of arrival estimation. The angle is inferred directly from a matrix of IQ samples that are recorded from the beamforming antenna. To estimate the angle of arrival, a 2×2 array antenna is used, where each of the 4 individual patch antennas is connected to a separate receiver. In embodiments, the antenna spacing is ½ of the wavelength of the RF carrier frequency that the antenna is designed for, with resultant 4 simultaneous signals. These signals can then be fed into the machine learning algorithm for angle estimation. Additionally, by applying phase shifts to the signals digitally, and then summing all the channels together, the signal power can be increased from a specific direction and rejected in other directions either via control of the receiver elements or as a digital processing step after capture. Similarly, transmitting a beam uses the same principle. By transmitting the same signal on 4 antennas, with phase shifts applied to each antenna, the resulting RF wave will have regions of constructive and destructive interference. In this manner, the highest power transmission angle can be steered, or “formed”, towards a particular receiver. In order to transmit to a particular receiver, a signal must be first received then its direction of origin estimated, or inferred, by calculating the angle of arrival at the antenna. Once this angle is known, the reply signal can be sent in that same direction.

Provided is a method of beamforming radio frequency (RF) signals in a satellite communication system. The method comprises receiving, at an antenna array that includes a set of antenna devices in communication with a control module of at least one of a satellite communication device and a base station communication device, a RF signal transmission, and based at least in part on a trained machine learning (ML) beamforming model, selecting a beamforming subset of the antenna devices of the antenna array that provides a best inference of an azimuth angle and an elevation angle of the satellite communication device relative to the base communication device.

Also provided is a satellite communication server computing system including a control module having one or more processors and a memory storing instructions. The instructions, when executed in the one or more processors, cause operations comprising receiving, at an antenna array that includes a set of antenna devices in communication with a control module of at least one of a satellite communication device and a base station communication device, a RF signal transmission, and based at least in part on a trained machine learning (ML) beamforming model, selecting a beamforming subset of the antenna devices of the antenna array that provides a best inference of an azimuth angle and an elevation angle of the satellite communication device relative to the base communication device.

Further provided is a non-transitory computer readable medium having processor-executable instructions stored thereon. The instructions, when executed in one or more processors cause operations comprising receiving, at an antenna array that includes a set of antenna devices in communication with a control module of at least one of a satellite communication device and a base station communication device, a RF signal transmission, and based at least in part on a trained machine learning (ML) beamforming model, selecting a beamforming subset of the antenna devices of the antenna array that provides a best inference of an azimuth angle and an elevation angle of the satellite communication device relative to the base communication device.

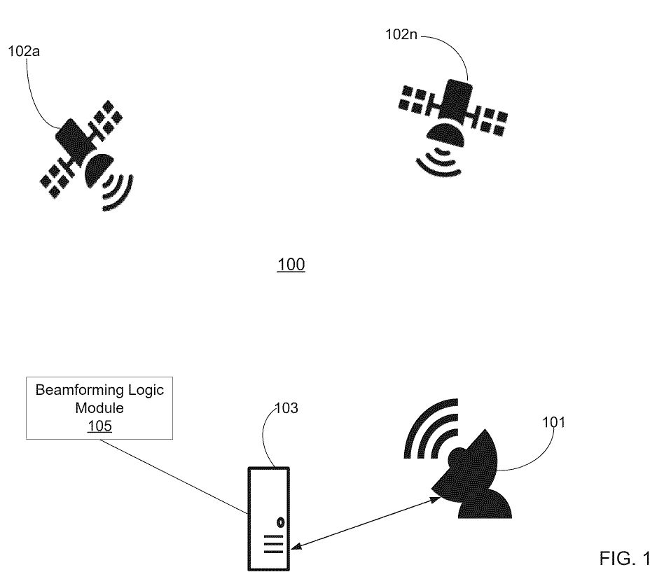

FIG. 1 illustrates, in an example embodiment, a machine learning based beamforming satellite communication system 100.

In embodiments, machine learning based beamforming satellite communication system 100 includes base communication device 101 communicatively coupled to satellite communication server computing system 103 that provides executable logic instructions constituting a control module for machine learning based beamforming satellite communication system 100. Base communication device 101 is in wireless radio frequency (RF) communication any number of orbiting satellite communication devices 102a . . . n. Base communication device 101 and satellite communication devices 102a . . . n are equipped with RF antenna arrays to enable RF communication therebetween, each antenna array including various configurations of antenna elements, also referred to herein as antenna devices. In embodiments, satellite communication server computing system 103 executable logic instructions that comprise beamforming logic module 105.

In some embodiments, base communication device 101 and satellite communication server computing system 103 may be included in a mobile platform, rather than a fixed platform or location. In some embodiments, is contemplated that the logic instructions that constitute beamforming logic module 105 may be hosted, partially or otherwise, in other computing or server system communicatively coupled to satellite communication server computing system 103 within, or communicatively accessible to, beamforming satellite communication system 100, as will be apparent to those of skill in the art of computer and communication networks.

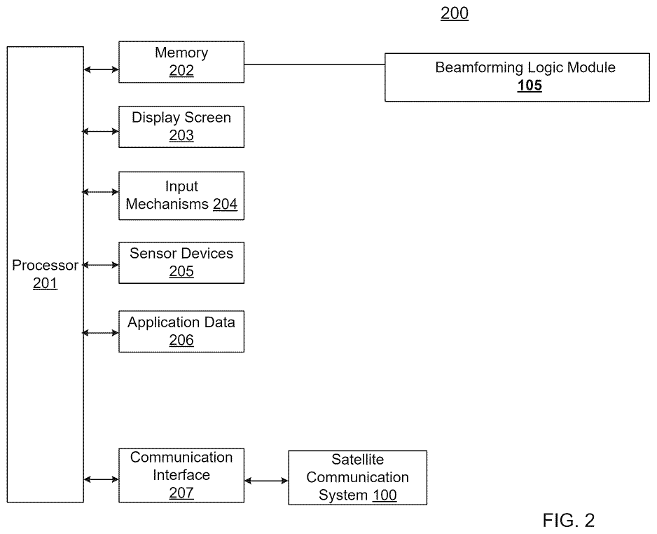

FIG. 2 illustrates, in another example embodiment, architecture 200 of a machine learning based beamforming satellite communication server computing system 103. Architecture 200, in embodiments, may be implemented on, for example, a server or combination of servers, or reside on base communication 101. In one implementation, architecture 200 includes processor resources 201, memory resources 202 (e.g., read-only memory (ROM) or random-access memory (RAM)), and a communication interface 207 communicatively coupled within satellite communication system 100. Memory resources 202 may include instructions constituting threat anomaly detection module 105 that are executable in processor 201. Memory resources 202 may also be used to store temporary variables or other intermediate information during execution of program instructions by processor 201.

Computer system 200 may include display screen 203 and input mechanisms 204. As described by various examples, processor 201 can detect and process any number of sensor inputs from input sensor devices 205. By way of example, such sensor inputs can include, but are not necessarily limited to, various sensor devices providing physical parameter measurements related to timing of signals as received from satellite navigation service, orbital mechanics of one or more satellites relative to properties of signals as propagated, RF signal characteristics in relation to satellite geospatial parameters, carrier-to-noise ratio associated with a satellite elevation relative to the receiver device 101, observed obstruction and signal propagation effects across frequency bands, and observed obstruction and signal propagation effects in relation to satellite geospatial parameters.

In addition to physical phenomena and physical parameters as sensed by sensor devices 205, system 200 can consume various kinds of inputs to represent context. For example, the system can be connected to a live calendar application, or similar current events application data 206 that indicates whether a high traffic event is taking place in the receiver device local surroundings. This can be a useful measure of context since a busy day may imply a noisier RF environment. In embodiments, application data module(s) 206 may be communicatively and logically accessible to processor 201 to augment information as acquired in accordance with sensor devices 205.

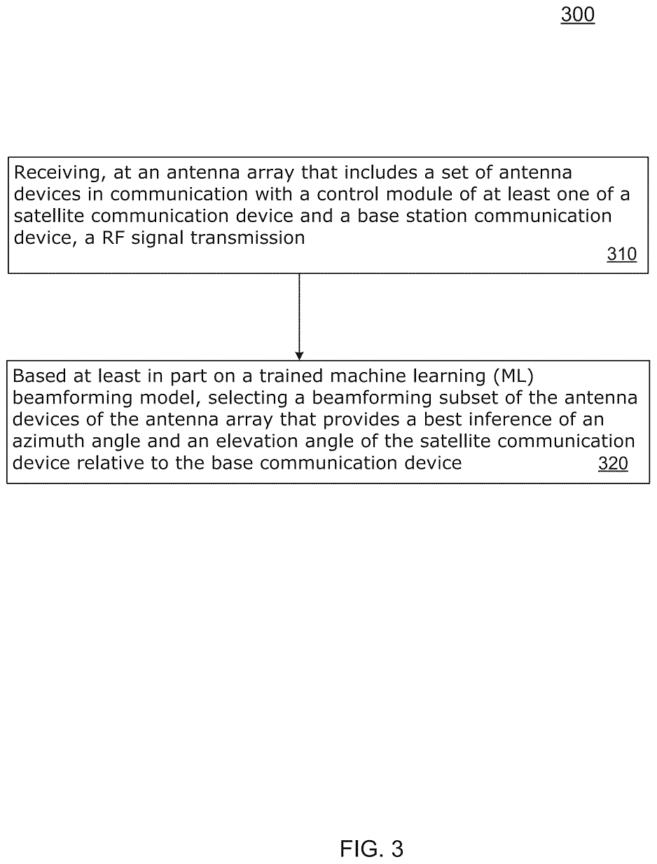

As such, examples described herein are related to the use of the computer system 200 for implementing the techniques described herein. According to an aspect, techniques are performed by the computer system 200 in response to the processor 201 executing one or more sequences of one or more instructions contained in memory 202. Such instructions may be read into memory 202 from another machine-readable medium. Execution of the sequences of instructions contained in memory 202 causes the processor 201 to perform the process steps described herein, including process steps of the embodiments described herein in conjunction with, for example, the embodiments as described in FIGS. 3-5 herein. In alternative implementations, hard-wired circuitry may be used in place of or in combination with software instructions to implement examples described herein. Thus, the examples described are not limited to any specific combination of hardware circuitry and software.

In some embodiments, communication interface 207 provides bi-directional communication and computing accessibility between satellite communication server computing system 200, including beamforming logic module 105 constituted therein, and other devices and systems of satellite communication system 100 as depicted in FIGS. 1-5 and as described herein.

In embodiments, beamforming logic module 105 of memory 202 includes logic instructions executable in processor 201. In embodiments, beamforming logic module 105 includes instructions for receiving, at an antenna array that includes a set of antenna devices in communication with a control module of at least one of satellite communication device 102a . . . n and base station communication device 101, a RF signal transmission.

Beamforming logic module 105 also includes instructions for receiving, based at least in part on a trained machine learning (ML) beamforming model, selecting a beamforming subset of the antenna devices of the antenna array that provides a best inference of an azimuth angle and an elevation angle of the satellite communication device relative to the base communication device

In some embodiment configurations, the antenna array comprises a 2×2 antenna array, and the azimuth and elevation angles are determined, based on the RF signal transmission, in accordance with an angle of arrival and an angle of departure in two axes.

In some aspects, beamforming logic module 105 also includes instructions for selecting, by the control module, the beamforming subset of the antenna devices in accordance with a beamforming vector determined as a best inference of the angle of arrival and departure in two axes of the satellite communication device among beamforming vectors that constitute a beam signature of the set of antenna devices.

In another aspect, beamforming logic module 105 further includes logic instructions for controlling, by the control module, transmission of the RF signal between the satellite communication device and the base communication device using a set of antenna beams in accordance with the selected beamforming subset of the antenna devices of the antenna array.

In an embodiment, beamforming logic module 105 further includes logic instructions for preparing a training set of hyperparameters in accordance with at least a plurality of RF signals, modulations, bandwidth and gains. Then further, training the ML neural network based at least in part on the training set. In some aspects, training the ML neural network may be based at least in part on capturing time and phase synchronized in phase quadrature (IQ) signal samples from each channel of a training channel array at different angles, different distances between a receiver and a transmitter channel, and different environmental conditions that include weather and time of day conditions.

In example embodiments, for instance related to a convolution neural network implementation, training the ML neural network comprises receiving, at an input layer of the ML neural network, the captured time and phase synchronized in phase quadrature (IQ) signal samples from each channel of a training channel array. Then, generating, at an output layer of the ML neural network, a location expressed in two axes in accordance with an azimuth angle and an elevation angle of the satellite communication device based on a configuration that includes a beamforming set of antenna devices. In this manner, a machine learning neural network is trained to take IQ samples from an array of coherent Software-Defined Radio (SDR) receivers and output an estimated angle of arrival.

In a particular example of training the model, System 1 simulating a satellite device, transmits towards system 2 that simulates a base receiver device, transmitting a variety of signals, modulations, bandwidths, and gains to provide diversity of parameters and parameter contexts for training. System 2 includes a motor-controlled motion platform guiding the antenna controller. System 2 rotates about two axes and captures time and phase synchronized IQ samples from each channel, saving them into a single file. In this particular example, it is a 2×2=4 channel array but this can be scaled arbitrarily based on antenna system design. System 2 does some pre-qualification to reject bad examples (no signal, bad signal, not meeting a specification), then labels the file with the physical angle of the servo motors—it sweeps all angles at a large range of the above. This process is repeated several times at different distances between Systems 1 and 2, using different angles of approach and departure, spacings, and in different environments (and possibly weather conditions and even days) to provide sufficient training data. Then design the model loading which takes in all 4 IQ channels into the model, thus split up into 8 channels total.

In another aspect, beamforming logic module 105 also includes logic instructions for iteratively repeating the training in optimization relative to achieving a threshold performance level of inferring a location expressed in accordance with an azimuth angle and an elevation angle of the satellite communication device 101a . . . n.

Yet further, beamforming logic module 105 also includes logic instructions for fine-tuning the trained ML beamforming neural network model by applying a pruning procedure that reduces branches and layers of the ML neural network, including input layers and intermediate or hidden layers in a convolutional neural network implementation embodiment, for instance, which are operationally are not in fact impacting or influencing classification in accordance with producing a minimum-parameter count ML neural network model. In this manner, higher computational efficacy and faster computational response times, among other technical advantages and benefits, can be achieved, for example by satellite communication server computing system 103, in accordance with such minimum-parameter count ML neural network model.

FIG. 3 illustrates, in another example embodiment, method 300 of operation in a machine learning based beamforming satellite communication system 100. Examples of method steps described herein are related to deployment and use of machine learning based beamforming satellite communication system 100 as described herein, in conjunction with any of the techniques, method steps, devices and systems as described in regard to FIGS. 1-4 herein. According to one embodiment, the techniques are performed in processor 201 executing one or more sequences of software logic instructions that constitute beamforming logic module 105. In embodiments, instructions constituting beamforming logic module 105 may be read into memory 202 from machine-readable medium, such as memory storage devices. Executing the instructions of beamforming logic module 105 stored in memory 202 causes processor 201 to perform the process steps described herein. In alternative implementations, at least some hard-wired circuitry may be used in place of, or in combination with, the software logic instructions that constitute beamforming logic module 105 in order to implement example embodiments described herein. Thus, the examples described herein are not limited to any particular combination of hardware circuitry and software instructions.

At step 310, receiving, at an antenna array that includes a set of antenna devices in communication with a control module of at least one of satellite communication device 102a . . . n and base station communication device 101, a RF signal transmission.

At step 320, based at least in part on a trained machine learning (ML) beamforming model, selecting a beamforming subset of the antenna devices of the antenna array that provides a best inference of an azimuth angle and an elevation angle of the satellite communication device relative to the base communication device

In some embodiment configurations, the antenna array comprises a 2×2 antenna array, and the azimuth and elevation angles are determined, based on the RF signal transmission, in accordance with an angle of arrival and an angle of departure in two axes.

In some aspects, the method further comprises selecting, by the control module, the beamforming subset of the antenna devices in accordance with a beamforming vector determined as a best inference of the angle of arrival and departure in two axes of the satellite communication device among beamforming vectors that constitute a beam signature of the set of antenna devices.

In one example embodiment, the method further comprises controlling, by the control module, transmission of the RF signal between the satellite communication device and the base communication device using a set of antenna beams in accordance with the selected beamforming subset of the antenna devices of the antenna array.

In yet another example embodiment, the ML beamforming neural network comprises a convolutional neural network (CNN) model.

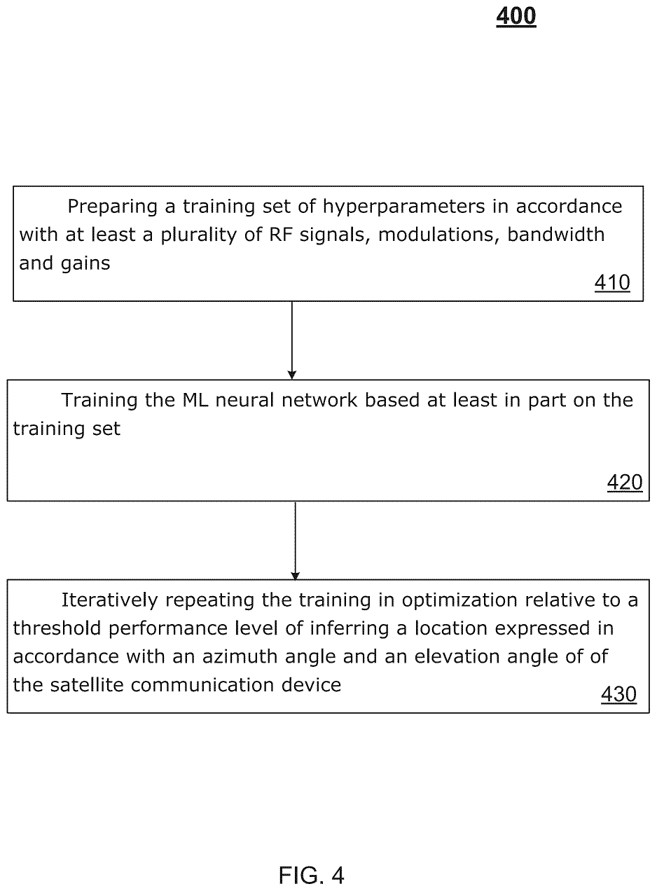

FIG. 4 illustrates, in an example embodiment, method 400 of training a machine learning neural network model for machine learning based beamforming satellite communication system 100. Examples of method steps described herein are related to deployment and use of machine learning based beamforming satellite communication system 100 as described herein, in conjunction with any of the techniques, method steps, devices and systems as described in regard to FIGS. 1-4 herein. According to one embodiment, the techniques are performed in processor 201 executing one or more sequences or configurations of software logic instructions that constitute beamforming logic module 105. In embodiments, instructions constituting beamforming logic module 105 may be read into memory 202 from machine-readable medium, such as memory storage devices. Executing the instructions of beamforming logic module 105 stored in memory 202 causes processor 201 to perform the process steps described herein. In alternative implementations, at least some hard-wired circuitry may be used in place of, or in combination with, the software logic instructions that constitute beamforming logic module 105 in order to implement example embodiments described herein. Thus, the examples described herein are not limited to any particular combination of hardware circuitry and software instructions.

At step 410, preparing a training set of hyperparameters in accordance with at least a plurality of RF signals, modulations, bandwidth and gains.

At step 420, training the ML neural network based at least in part on the training set. In some aspects, training the ML neural network may be based at least in part on capturing time and phase synchronized in phase quadrature (IQ) signal samples from each channel of a training channel array at different angles, different distances between a receiver and a transmitter channel, and different environmental conditions that include weather and time of day conditions.

In example embodiments, for instance related to a convolution neural network implementation, training the ML neural network comprises receiving, at an input layer of the ML neural network, the captured time and phase synchronized in phase quadrature (IQ) signal samples from each channel of a training channel array. Then, generating, at an output layer of the ML neural network, a location expressed in two axes in accordance with an azimuth angle and an elevation angle of the satellite communication device based on a configuration that includes a beamforming set of antenna devices.

At step 430, iteratively repeating the training in optimization relative to a threshold performance level of inferring a location expressed in accordance with an azimuth angle and an elevation angle of the satellite communication device 101a . . . n.

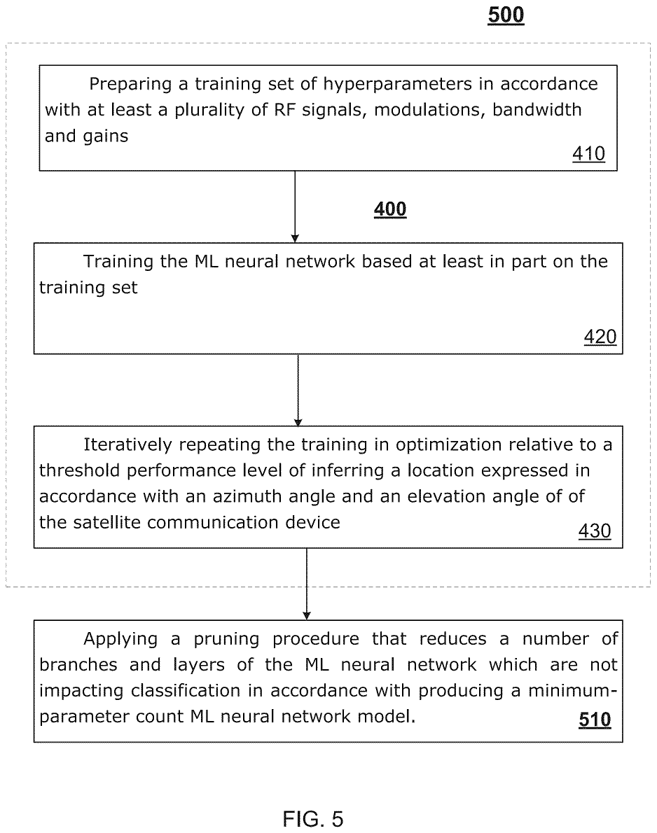

FIG. 5 illustrates, in an example embodiment, method 500 of applying a pruning procedure in training a machine learning neural network model for machine learning based beamforming satellite communication system 100. In the example embodiment as depicted in FIG. 5, the pruning procedure may be deployed in conjunction with the steps as described herein with regard to FIG. 4.

At step 510, further fine-tuning the trained ML beamforming neural network model by applying a pruning procedure that reduces branches and layers of the ML neural network, including input layers and intermediate or hidden layers in a convolutional neural network implementation embodiment, for instance, which are operationally are not in fact impacting or influencing classification in accordance with producing a minimum-parameter count ML neural network model. In this manner, higher computational efficacy and faster computational response times, among other technical advantages and benefits, can be achieved, for example by satellite communication server computing system 103, in accordance with such minimum-parameter count ML neural network model.

In further embodiments, the system incorporates machine learning models for interference recognition and intelligent suppression, enabling adaptive nulling, virtual nulling and dynamic interference mitigation in satellite and terrestrial communication environments. The system is capable of resolving multiple simultaneous sources, including scenarios with power imbalance and multipath effects, by leveraging both synthetic and real-world datasets for training. The training process includes the generation of multi-source data through superposition and controlled noise injection, as well as calibration procedures to ensure phase and time synchronization across antenna channels.

The beamforming logic module may further comprise a two-stage architecture, wherein a convolutional neural network (CNN) predicts phase vectors for each antenna channel. These phase vectors are subsequently applied in a differentiable phase-shift and sum layer, implemented in software, to separate desired signals from interferers and enable interference suppression. The model is trained end-to-end using custom loss functions, including hybrid correlation-based losses that balance the boosting of desired signals and the nulling of interferers. For example, the loss function may be defined as:

L=α(1−corr(output,incumbent))+(1−α)corr(output,interferer)

where is α tunable parameter.

The system is designed to operate on both calibrated and uncalibrated receivers, with the model capable of compensating for random phase and gain offsets between antenna channels. This enables deployment in environments where hardware calibration may be impractical or subject to drift over time. The architecture supports various antenna array configurations, including uniform linear arrays (ULA), uniform rectangular arrays, and coprime arrays, and does not require frequency-specific antenna spacing.

Performance metrics for the system include angle root mean squared error (RMSE) for multi-signal AoA estimation, null depth for interference suppression, and post-nulling signal-to-interference-and-noise ratio (SINR) improvement. The system has demonstrated robust operation in live basestation environments, achieving repeatable interference recognition and suppression under active jamming and generalizing to out-of-distribution signals such as FM broadcasts and wideband interferers.

In regulatory contexts, particularly in cross-border and shared spectrum environments, the system provides adaptive interference mitigation, allowing for reduced coverage gaps and improved coexistence between terrestrial and non-terrestrial networks. The system may be integrated with AI radio resource schedulers to dynamically assign resources and adapt to environmental conditions, further enhancing communication reliability and throughput.

The model architecture may include input shapes of float32 representing I and Q channels from four antennas, and output vectors comprising phase and gain parameters for signal isolation. The phase and sum function is fully differentiable, allowing for end-to-end training without reliance on classical ground truth calculations such as autocorrelation matrices or explicit angle-of-arrival estimation. In addition, the model architecture can be scaled, up or down, and the instant description can be adapted to a subset of antennae of a larger antenna array.

In further embodiments, the following technical details and procedures are provided.

### Training Data Generation and Labeling

To enable robust machine learning (ML) models for beamforming and interference suppression, the system utilizes both synthetic and real-world datasets. Synthetic datasets are generated by superimposing single-source IQ data from various modulations, bandwidths, and gain levels, creating multi-source scenarios with controlled signal-to-interference-and-noise ratio (SINR) and additive white Gaussian noise (AWGN). Real-world datasets are collected using a uniform linear array (ULA) or other antenna configurations, with synchronized sampling clocks and phase alignment procedures.

For multi-source angle-of-arrival (AoA) estimation, the training data includes incumbent (desired) signals, generated or recorded from communication systems such as QPSK or 5G uplink, and interferer signals, which may be synthesized (for example, linear frequency modulation (LFM) chirps) or recorded from ambient sources such as FM, LTE, or WiFi. Combined signals are created by summing incumbent and interferer signals with randomized gain offsets and added noise. Ground truth labels for desired and interference signals are generated by phase-aligning and summing the component signals across all antenna channels, reducing noise and bias. Calibration procedures may involve rotating the receiver array and capturing data at multiple angular positions to ensure phase and time synchronization.

### Model Architecture and Implementation

The ML model comprises a convolutional neural network (CNN) with a two-stage architecture. The input layer accepts IQ samples from four antennas, formatted as an float32 array (I and Q for each antenna). Multiple convolutional layers extract spatial and temporal features from the input data, with an example configuration including 2-4 layers and 32-256 neurons per layer, using ReLU activation. The CNN outputs a vector of phase and gain parameters for each antenna channel. For two-signal separation, the output is a vector (3 phase values and 4 gain values per signal). The predicted phase and gain vectors are applied to the input signals in a differentiable phase-shift and sum layer, and the channels are summed to produce isolated signals for the incumbent and interferer. This layer is fully differentiable, enabling end-to-end training. The gains are normalized such that their average equals one, and the phase of channel 0 is set to zero for each signal, constraining the degrees of freedom and ensuring physical realizability.

### Loss Function Specification

Training employs custom loss functions to optimize both signal boosting and interference nulling. The primary loss function is a hybrid correlation metric:

$$L = α ( 1 - corr ( output , incumbent ) ) + ( 1 - α ) corr ( output , interferer )$$

where is a tunable parameter (for example, 0.3), and denotes the normalized cross-correlation between the output and the target signal. Alternative loss functions, such as mean squared error (MSE) and L1 loss, may be used for regression tasks or to penalize outliers. For angle estimation, a square-root loss may be used to reward precision improvements proportionally across the error range. Loss function selection and parameter tuning are performed empirically, with validation on held-out datasets. Advantageously, the customized loss function is made more efficient by first defining a cross-correlation score that quantifies how well two signals align. Using this score, a loss function is constructed that simultaneously encourages high correlation with the target incumbent signal while penalizing correlation with the interfering signal.

### Calibration and Operation on Uncalibrated Hardware

The system is designed to operate on both calibrated and uncalibrated receivers. In calibrated operation, all ADCs are tied to a common sample clock, and reference signals are used to calibrate phase and gain offsets. In uncalibrated operation, during training, random phase shifts and gain offsets are applied to each channel to simulate hardware drift. The model learns to compensate for these offsets, enabling deployment in environments where calibration is impractical or subject to change over time. Calibration procedures may include systematic validation of antenna-to-channel cabling, phase alignment across channels, and periodic recalibration as needed.

### System Integration and Deployment

The ML model is integrated with satellite and terrestrial communication systems as follows. For software integration, the model is deployed within the beamforming logic module of the satellite communication server or base station, interfacing with software-defined radio (SDR) platforms such as srsRAN. For hardware integration, the system supports various antenna array configurations, including ULA, uniform rectangular arrays, and coprime arrays, without requiring frequency-specific spacing. The ML model may be combined with AI radio resource schedulers to dynamically assign resources, adapt to environmental conditions, and mitigate interference in real time.

Integration steps include: (1) capturing IQ samples from the antenna array; (2) applying pre-processing steps to the IQ samples, similar to the training IQ samples; (3) feeding samples to the ML model for phase/gain prediction; (4) applying predicted parameters to the antenna channels for beamforming and nulling; and (5) monitoring performance metrics and adapting model parameters as needed. It will be appreciated, as indicated above, that nulling also includes virtual nulling. Transmit nulling is only adaptive nulling whereas receiver nulling includes both virtual and adaptive nulling.

### Performance Metrics and Validation

System performance is evaluated using the following metrics: angle root mean squared error (RMSE) for multi-signal AoA estimation, null depth for interference suppression (quantified in decibels, with target performance of at least 15-20 dB nulling on unseen interferers), and post-nulling signal-to-interference-and-noise ratio (SINR) improvement. The model is validated on out-of-distribution signals (such as FM broadcasts and wideband interferers) to ensure robustness. Experimental results are obtained through laboratory and field testing, with benchmarks against classical algorithms (such as MVDR and MUSIC) and live demonstrations under active jamming scenarios.

### Environmental Adaptation and Regulatory Compliance

The system adapts to changing environments and regulatory constraints by incorporating sensor inputs (for example, weather, time of day, and traffic events) and environmental property measurements (such as ambient temperature and topological information). Predictive analytics and AI scheduling may be used to forecast aggregate equivalent power flux density (EPFD) and schedule traffic accordingly. Adaptive interference mitigation is implemented to reduce coverage gaps and improve coexistence between terrestrial and non-terrestrial networks, especially in border regions.

### Algorithmic Steps for Inference and Suppression

A typical operational flow for interference recognition and suppression is as follows, with an understanding that the receiver is already calibrated, usually the first time the receiver is turned on:
1. Data Acquisition: Receive IQ samples from the antenna array.
2. Preprocessing: Normalize and synchronize samples.
3. Inference: Input samples to the trained ML model; obtain phase and gain vectors.
4. Beamforming/Nulling: Apply phase/gain vectors to antenna channels; sum channels to isolate desired and interference signals (this includes virtual nulling).
5. Performance Monitoring: Measure output metrics (such as SINR and null depth); adjust model parameters or retrain as needed.
6. Resource Scheduling: Interface with AI scheduler for dynamic resource assignment and regulatory adaptation.

### Example Pseudocode for ML-Based Nulling

The following pseudocode illustrates the ML-based interference suppression process:
def ml_nulling_inference(iq_samples, model): #iq_samples: 8×N array (I/Q from 4 antennas) #model: trained CNN for phase/gain prediction

# Step 1: Preprocess input
iq_normalized = preprocess(iq_samples)
# Step 2: Predict phase/gain vectors
phase_gain_vector = model.predict(iq_normalized)
# Step 3: Apply phase/gain to input channels
isolated_signals = phase_shift_and_sum(iq_normalized,
phase_gain_vector)
# Step 4: Output desired and interference signals
return isolated_signals[‘desired’],
isolated_signals[‘interferer’]

### Example Neural Network Configuration

An example neural network configuration is as follows:
Input: float32 IQ samples
Layers: 3 convolutional layers (32, 64, 128 filters), kernel size 5, ReLU activation, and adaptive average pooling
Output: vector (phases and gains for two signals)
Final activation: Sigmoid scaled to [0, 2π] for phases; normalization for gains
Loss: Hybrid correlation-based loss as defined above

### Experimental Results and Benchmarks

In experimental validation, the system achieved multi-signal AoA RMSE of less than 3 degrees for balanced power and less than 10 degrees for a +3 dB offset. Null depth of 15-20 dB suppression was observed on unseen interferers. SINR improvement ranged from 8-17 dB post-nulling, compared to 27 dB for the MVDR baseline. The model maintained nulling on FM, wideband, and out-of-scope signals.

In certain embodiments, angle-of-arrival (AoA) estimation and receiver-side nulling are performed entirely without commanding beam steering of the antenna array. The machine learning (ML) model operates directly on raw in-phase and quadrature (IQ) data streams from respective antenna channels and digitally applies per-channel phase and gain adjustments or post-processing transformations to suppress unwanted signals while boosting desired signals. This receiver-side functionality does not require any control of physical element excitations or mechanical pointing; beam steering control is only needed where transmit angle-of-departure (AoD) shaping or transmitter-side nulling is desired.

The ML model can perform the tasks of handcrafted algorithms directly from raw IQ streams with low computational footprint and latency. In exemplary embodiments the model uses fewer than 20,000 trainable parameters and produces predictions in under 20 milliseconds on a 2×2 array, while scaling to larger arrays when available.

The system can operate on small arrays, including a 2×2 array, and on a subset of a larger array. For example, a 1×2 subarray of a 1×4 or 2×2 configuration can be used, and the model can dynamically select a subarray that optimizes desired signal quality or null depth.

The model outputs may include azimuth and elevation estimates and/or per-channel phase and gain parameters for signal isolation. Operating modes include: (i) AoA-only mode, in which inferred azimuth and elevation are produced without issuing any array control; (ii) receiver nulling mode, in which per-channel phase and gain parameters are digitally applied to recorded IQ streams to isolate desired signals and suppress interferers without array control; and (iii) transmitter nulling mode, in which per-element excitations are commanded to reduce radiated energy toward protected directions while maintaining radiated energy toward target directions.

Transmitter-side nulling is particularly advantageous for regulatory compliance and tactical use. In border regions, transmitter nulling can reduce interference into non-incumbent territories by limiting energy in protected directions. In tactical contexts, transmitter nulling can reduce detectability by non-cooperative actors while preserving service to target users.

Strict calibration to common phase and time references is not required. The model compensates for random phase and gain offsets between antenna channels and operates provided the channels remain consistent with each other during operation. In embodiments, channel consistency checks replace traditional phase/time synchronization requirements, and the model learns offset-invariant representations during training.

Although embodiments are described in detail herein with reference to the accompanying drawings, it is intended that disclosures herein not be limited to literal depictions of the embodiments illustrated by way of examples. As such, many modifications and equivalents of the machine learning based RF signal beamforming techniques, and variations in sequence of the method steps in deployment thereof, will be apparent to practitioners skilled in the art. Accordingly, it is intended that the invention encompasses scope in accordance with the following claims and their equivalents. Furthermore, it is contemplated that a particular feature described either individually or as part of an embodiment can be combined with other individually described features, or portions of other embodiments described herein. Thus, absence of described particular combinations does not preclude the inventor from claiming rights to such combinations.

What is claimed is:

1. A method of beamforming radio frequency (RF) signals in a satellite communication system, the method comprising:
receiving, at an antenna array comprising a plurality of antenna devices in communication with a control module of at least one of a satellite communication device and a base station communication device, a RF signal transmission;
processing the received RF signal transmission, by a trained machine learning (ML) model comprising a convolutional neural network, to:
(a) recognize and classify interference signals in real time;
(b) select a beamforming subset of the antenna devices and corresponding phase and gain parameters to maximize signal quality for a desired signal and adaptively suppress one or more interfering signals;
wherein the ML model is trained end-to-end using at least one of synthetic and real-world datasets, and is operable on both calibrated and uncalibrated receivers by compensating for random phase and gain offsets between antenna channels.

2. The method of claim 1 wherein the antenna array comprises a 2×2 antenna array, and the azimuth and elevation angles are determined, based on the RF signal transmission, in accordance with an angle of arrival and an angle of departure in two axes.

3. The method of claim 2 further comprising selecting, by the control module, the beamforming subset of the antenna devices in accordance with a beamforming vector determined as a best inference of the angle of arrival and departure in two axes of the satellite communication device among beamforming vectors that constitute a beam signature of the set of antenna devices.

4. The method of claim 1 further comprising controlling, by the control module, transmission of the RF signal between the satellite communication device and the base communication device using a set of antenna beams in accordance with the selected beamforming subset of the antenna devices of the antenna array.

5. The method of claim 1 wherein the trained ML beamforming model is trained in accordance with operations comprising:
preparing a training set of hyperparameters in accordance with at least a plurality of RF signals, modulations, bandwidth and gains; and
training the ML neural network based at least in part on the training set.

6. The method of claim 5 wherein training the ML neural network is based at least in part on capturing time and phase synchronized in phase quadrature (IQ) signal samples from each channel of a training channel array at different angles, different distances between a receiver and a transmitter channel, and different environmental conditions that include weather and time of day conditions.

7. The method of claim 6 wherein training the ML neural network comprises
receiving, at an input layer of the ML neural network, the captured time and phase synchronized in phase quadrature (IQ) signal samples from each channel of a training channel array; and
generating, at an output layer of the ML neural network, a location expressed in two axes in accordance with an azimuth angle and an elevation angle of the satellite communication device based on a configuration that includes a beamforming set of antenna devices.

8. The method of claim 1, wherein the ML further includes a differentiable phase-shift and sum layer.

9. The method of claim 1, further comprising transmitting or receiving RF signals using the selected beamforming subset and parameters, such that the system is adapted to resolve multiple simultaneous sources and generalizing to out-of-distribution interference scenarios.

10. A satellite communication server system comprising:
a control module in communication with at least one of a satellite communication device and a base station communication device, the control module including:
one or more processor devices; and
a memory storing instructions executable in the one or more processor devices, the instructions causing the one or more processor devices to execute operations comprising:
receiving, at an antenna array comprising a plurality of antenna devices, a RF signal transmission;
processing, by a trained machine learning model comprising a convolutional neural network the received RF signal transmission to:
(a) recognize and classify interference signals in real time;
(b) select a beamforming subset of the antenna devices and corresponding phase and gain parameters to maximize signal quality for a desired signal and adaptively suppress one or more interfering signals;
wherein the machine learning model is trained end-to-end using at least one of synthetic and real-world datasets, and is operable on both calibrated and uncalibrated receivers by compensating for random phase and gain offsets between antenna channels.

11. The satellite communication server system of claim 10 wherein the antenna array comprises a 2×2 antenna array, and the azimuth and elevation angles are determined, based on the RF signal transmission, in accordance with an angle of arrival and an angle of departure in two axes.

12. The satellite communication server system of claim 11 further comprising instructions for selecting, by the control module, the beamforming subset of the antenna devices in accordance with a beamforming vector determined as a best inference of the angle of arrival and departure in two axes of the satellite communication device among beamforming vectors that constitute a beam signature of the set of antenna devices.

13. The satellite communication server system of claim 10 further comprising instructions for controlling, by the control module, transmission of the RF signal between the satellite communication device and the base communication device using a set of antenna beams in accordance with the selected beamforming subset of the antenna devices of the antenna array.

14. The satellite communication server system of claim 10 wherein the trained ML beamforming model is trained in accordance with instructions causing operations comprising:
preparing a training set of hyperparameters in accordance with at least a plurality of RF signals, modulations, bandwidth and gains; and
training the ML neural network based at least in part on the training set.

15. The satellite communication server system of claim 14 wherein training the ML neural network is based at least in part on capturing time and phase synchronized in phase quadrature (IQ) signal samples from each channel of a training channel array at different angles, different distances between a receiver and a transmitter channel, and different environmental conditions that include weather and time of day conditions.

16. The satellite communication server system of claim 15 wherein training the ML neural network includes instructions causing operations comprising:
receiving, at an input layer of the ML neural network, the captured time and phase synchronized in phase quadrature (IQ) signal samples from each channel of a training channel array; and
generating, at an output layer of the ML neural network, a location expressed in two axes in accordance with an azimuth angle and an elevation angle of the satellite communication device based on a configuration that includes a beamforming set of antenna devices.

17. The system of claim 16, wherein the ML further includes a differentiable phase-shift and sum layer.

18. The system of claim 17, wherein the system is further adapted to transmit or receive RF signals using the selected beamforming subset and parameters, such that the system is adapted to resolve multiple simultaneous sources and generalizing to out-of-distribution interference scenarios.

19. A non-transitory computer readable storage medium having instructions stored thereon, the instructions being executable in one or more processors to cause operations comprising:
receiving, in a satellite communication system, at an antenna array that includes a set of antenna devices in communication with a control module of at least one of a satellite communication device and a base station communication device, a RF signal transmission; and
based at least in part on a trained machine learning (ML) beamforming model, selecting a beamforming subset of the antenna devices of the antenna array that provides a best inference of an azimuth angle and an elevation angle of the satellite communication device relative to the base communication device.

20. A method of processing radio frequency (RF) signals in a satellite communication system, the method comprising:
a. receiving, at an antenna array comprising a plurality of antenna devices coupled to a receiver, raw in-phase and quadrature (IQ) data streams corresponding to respective antenna channels for a RF signal transmission;
b. processing, by a trained machine learning (ML) model operating directly on the raw IQ data streams, the received RF signal transmission to perform at least one of:
i. angle-of-arrival (AoA) estimation of the RF signal to infer an azimuth angle and an elevation angle without commanding beam steering of the antenna array; and
ii. receiver-side nulling, including digitally applying phase and gain adjustments per channel or post-processing transformations to the IQ data streams to suppress at least one unwanted interference signal while boosting at least one desired signal, without commanding beam steering of the antenna array;
wherein the ML model is trained end-to-end using synthetic and real-world datasets and is operable on calibrated and uncalibrated receivers by compensating for random phase and gain offsets between antenna channels with a requirement of channel consistency during operation, and
wherein the ML model is configured to output at least one of:
(i) an azimuth and elevation estimate, and
(ii) per-channel phase and gain parameters for signal isolation, and wherein the method is further configured to operate on a subarray of a larger antenna array, including a 1×2 subset of a 1×4 or a 2×2 array, and on small arrays including a 2×2 array.

21. A satellite communication server system comprising:
a receiver coupled to an antenna array comprising a plurality of antenna devices;
one or more processors; and
a memory storing instructions that, when executed by the one or more processors, cause operations comprising:
a. receiving, as raw in-phase and quadrature (IQ) data streams, signals from respective antenna channels of the antenna array;
b. processing, by a trained machine learning model operating directly on the raw IQ data streams and comprising a convolutional neural network and a differentiable phase-shift and sum layer, the received signals to perform at least one of:
a. angle-of-arrival (AoA) estimation to infer azimuth and elevation without commanding beam steering of the antenna array; and
b. receiver-side nulling including digitally applying phase and gain adjustments per channel or post-processing transformations to suppress one or more interference signals while boosting a desired signal without commanding beam steering of the antenna array; and
c. if transmit beam control is desired, computing phase and gain parameters for transmitter-side nulling and beam shaping to reduce radiated energy toward a protected direction and maintain radiated energy toward a target direction;
wherein the machine learning model is trained end-to-end using at least one of synthetic and real-world datasets, is operable on calibrated and uncalibrated receivers by compensating for random phase and gain offsets between antenna channels with a requirement of channel consistency during operation, and is configured to output at least one of:
(i) azimuth and elevation, and
(ii) per-channel phase and gain parameters for signal isolation, and wherein the system is configured to operate on small arrays including a 2×2 array or on a subarray of a larger antenna array.

22. A non-transitory computer readable storage medium having instructions stored thereon, the instructions being executable by one or more processors to cause operations comprising: receiving raw in-phase and quadrature (IQ) data streams from respective channels of an antenna array in a satellite communication system; and processing, by a trained machine learning model operating directly on the raw IQ data streams, the received signals to perform at least one of: (a) angle-of-arrival (AoA) estimation to infer azimuth and elevation without commanding beam steering of the antenna array; and (b) receiver-side nulling including digitally applying phase and gain adjustments per channel or post-processing transformations to suppress one or more interference signals while boosting a desired signal without commanding beam steering of the antenna array; and optionally computing, when transmit beam control is desired, phase and gain parameters for transmitter-side nulling and beam shaping to reduce radiated energy toward a protected direction while maintaining radiated energy toward a target direction; wherein the machine learning model is trained end-to-end using synthetic and real-world datasets, is operable on calibrated and uncalibrated receivers by compensating for random phase and gain offsets between antenna channels with a requirement of channel consistency during operation, and is configured to output at least one of: (i) azimuth and elevation, and (ii) per-channel phase and gain parameters for signal isolation, and wherein the operations are executable on small arrays including a 2×2 array or on a subarray of a larger antenna array.

23. A method performed by a control module of a satellite communication node for processing radio frequency (RF) signals, the method comprising:
a. receiving, at an antenna array of the satellite communication node comprising a plurality of antenna devices coupled to the control module, raw in-phase and quadrature (IQ) data streams corresponding to respective antenna channels for a RF signal transmission;
b. processing, by a trained machine learning (ML) beamforming model executing in the control module and operating directly on the raw IQ data streams, the received RF signal transmission to:
i. recognize and classify interference signals in real time; and
ii. select a beamforming subset of the antenna devices and corresponding per-channel phase and gain parameters to maximize signal quality for a desired signal and adaptively suppress one or more interfering signals without commanding beam steering of the antenna array;
wherein the ML beamforming model comprises a convolutional neural network and a differentiable phase-shift and sum layer, is trained end-to-end using at least one of synthetic and real-world datasets, and is operable on calibrated and uncalibrated receivers by compensating for random phase and gain offsets between antenna channels with a requirement of channel consistency during operation; and wherein
the method further comprises, by the control module, optionally computing and commanding transmit-side phase and gain parameters to the antenna array to control an angle-of-departure and reduce radiated energy toward at least one protected direction while maintaining radiated energy toward at least one target direction;
such that the satellite communication node resolves multiple simultaneous sources and generalizes to out-of-distribution interference scenarios, and the ML beamforming model is configured to output at least one of:
i. an azimuth and elevation estimate, and
j. per-channel phase and gain parameters for signal isolation.

24. The method of claim 23 wherein the antenna array comprises a 2×2 array and the control module operates on a subarray of the antenna array including a 1×2 subset of a 1×4 or a 2×2 configuration.

25. The method of claim 23 wherein the ML beamforming model has fewer than 20,000 trainable parameters and produces phase and gain predictions with latency less than 20 milliseconds on the 2×2 array.

26. The method of claim 23 wherein the differentiable phase-shift and sum layer applies the predicted per-channel phase and gain parameters to the raw IQ data streams and sums the channels to isolate an incumbent signal and suppress at least one interferer.

27. The method of claim 23 wherein receiver-side nulling comprises digitally applying per-channel phase and gain adjustments or post-processing transformations to the recorded IQ streams to suppress an unwanted signal and boost a desired signal without issuing any array control commands.

28. The method of claim 23 wherein the optionally commanded transmit-side phase and gain parameters implement transmitter-side nulling to limit interference across an international border or to reduce detectability by a non-cooperative actor while maintaining service to a target user.

29. The method of claim 23 wherein training the ML beamforming model includes applying randomized phase shifts and gain offsets and additive white Gaussian noise to the training channels to simulate hardware drift and interference conditions.

30. The method of claim 23 wherein training further comprises capturing time- and phase-aligned IQ samples from each channel at different angles, at different distances between a receiver and a transmitter, and under different environmental conditions including weather and time of day.

31. The method of claim 24 wherein the ML beamforming model outputs azimuth and elevation, and the control module executes an angle-of-arrival-only mode in which inferred azimuth and elevation are produced without issuing any array control.

32. The method of claim 23 wherein the ML beamforming model outputs per-channel phase and gain parameters, and the control module executes a receiver-nulling mode in which the parameters are digitally applied to the recorded IQ streams without array control.

33. The method of claim 23 further comprising monitoring performance metrics including null depth of at least 15 dB suppression on unseen interferers and post-nulling signal-to-interference-and-noise ratio improvement relative to baseline methods.

34. A satellite communication server system comprising:
a. a receiver coupled to an antenna array comprising a plurality of antenna devices of a satellite communication node;
b. one or more processors; and
c. a memory storing instructions that, when executed by the one or more processors, cause operations comprising:
i. receiving, as raw in-phase and quadrature data streams, signals from respective antenna channels of the antenna array;
ii. processing, by a trained machine learning beamforming model operating directly on the raw IQ data streams and comprising a convolutional neural network and a differentiable phase-shift and sum layer, the received signals to:
1. recognize and classify interference signals in real time; and
2. select a beamforming subset of the antenna devices and corresponding per-channel phase and gain parameters to maximize signal quality for a desired signal and adaptively suppress one or more interfering signals without commanding beam steering of the antenna array;
wherein the machine learning beamforming model is trained end-to-end using at least one of synthetic and real-world datasets, is operable on calibrated and uncalibrated receivers by compensating for random phase and gain offsets between antenna channels with a requirement of channel consistency during operation, and is configured to output at least one of:
azimuth and elevation and per-channel phase and gain parameters for signal isolation; and
if desired, computing and commanding transmit-side phase and gain parameters to the antenna array to control an angle-of-departure and reduce radiated energy toward at least one protected direction while maintaining radiated energy toward at least one target direction.

35. The satellite communication server system of claim 34 wherein the antenna array comprises a 2×2 array and the instructions cause operation on a subarray including a 1×2 subset of a 1×4 or a 2×2 configuration.

36. The satellite communication server system of claim 34 wherein the machine learning beamforming model has fewer than 20,000 trainable parameters, produces phase and gain predictions with latency less than 20 milliseconds on the 2×2 array, and applies the predicted parameters in the differentiable phase-shift and sum layer to isolate desired and interference signals.

37. The satellite communication server system of claim 34 wherein the system is operable on uncalibrated receivers by executing channel consistency checks and compensating for random phase and gain offsets learned during training.

38. The satellite communication server system of claim 34 further comprising instructions to interface with an AI radio resource scheduler to dynamically assign resources and adapt to environmental and regulatory conditions.

39. A non-transitory computer readable storage medium having instructions stored thereon, the instructions being executable by one or more processors of a satellite communication node to cause operations comprising: receiving raw in-phase and quadrature data streams from respective channels of an antenna array of the satellite communication node; processing, by a trained machine learning beamforming model operating directly on the raw IQ data streams and comprising a convolutional neural network and a differentiable phase-shift and sum layer, the received signals to perform at least one of: (a) angle-of-arrival estimation to infer azimuth and elevation without commanding beam steering of the antenna array; and (b) receiver-side nulling including digitally applying per-channel phase and gain adjustments or post-processing transformations to suppress one or more interference signals while boosting a desired signal without commanding beam steering of the antenna array; and optionally computing and commanding transmit-side phase and gain parameters to the antenna array to reduce radiated energy toward a protected direction while maintaining radiated energy toward a target direction; wherein the machine learning beamforming model is trained end-to-end using at least one of synthetic and real-world datasets, is operable on calibrated and uncalibrated receivers by compensating for random phase and gain offsets between antenna channels with a requirement of channel consistency during operation, and is configured to output at least one of: azimuth and elevation and per-channel phase and gain parameters for signal isolation.

40. The non-transitory computer readable storage medium of claim 39 wherein the instructions cause operations on small arrays including a 2×2 array and on a subarray of a larger antenna array.
